(19) United States
(12) Patent Application Publication
(10) Pub. No.: US 2023/0412382 A1
(43) Pub. Date: Dec. 21, 2023

(54) SYSTEMS AND METHODS FOR MANAGING ACCESS TO A RESOURCE

(71) Applicant: GRAIL, LLC, Menlo Park, CA (US)

(72) Inventors: Prabhu PALANISAMY, Fremont, CA (US); Satnam ALAG, Santa Clara, CA (US); Milan KARANGUTKAR, Santa Clara, CA (US)

(73) Assignee: GRAIL, LLC, Menlo Park, CA (US)

(21) Appl. No.: 18/335,432

(22) Filed: Jun. 15, 2023

Related U.S. Application Data
(60) Provisional application No. 63/366,497, filed on Jun. 16, 2022.

(51) Int. Cl. H04L 9/32; H04L 9/08; H04L 9/40

(52) U.S. Cl. CPC H04L 9/3213; H04L 9/0825; H04L 63/104

(57) ABSTRACT

Systems and methods of providing access to a resource via an access management system may include: receiving, at an authorization server, a login request to a user profile from a client application, wherein the login request comprises a set of login credentials; transmitting, from the authorization server to an identity provider, the set of login credentials; authenticating, upon validation of the set of login credentials by the identity provider, the user; receiving, at the authorization server and subsequent to the authenticating, an authentication request from the client application; issuing, subsequent to validating the authentication request and by the authorization server, an access token to the client application; detecting, at a resource server, a request from the client application to access a resource, wherein the request comprises the access token; and enabling, by the resource server and responsive to validating the access token, the client application access to the resource.

### CROSS REFERENCE TO RELATED APPLICATIONS

This application claims priority to U.S. Provisional Application No. 63/366,497, filed on Jun. 16, 2022, which is incorporated by reference herein in its entirety.

### TECHNICAL FIELD

The present disclosure relates generally to the field of resource access management and, more particularly, to systems and methods for enabling user capabilities with respect to a resource based on designated user permissions.

### BACKGROUND

Many entities (e.g., companies, businesses, organizations, etc.) preside over a variety of different types of resources (e.g., data and information associated with various aspects of the entity). The sensitivity of these resources may vary and may correspondingly call for different levels of authorization to access and/or interact with. Effectively managing user enablements with respect to resource access and interaction has conventionally been challenging. Accordingly, the present disclosure is directed to improving resource access management by utilizing a federated authentication and authorization infrastructure that is interoperable with affiliated and non-affiliated entity systems.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In summary, one aspect provides a method of providing access to a resource via an access management system, the method including: receiving, at an authorization server associated with the access management system, a login request to a user profile from a client application, wherein the login request comprises a set of login credentials; transmitting, from the authorization server to an identity provider associated with the access management system, the set of login credentials; authenticating, upon validation of the set of login credentials by the identity provider, the user; receiving, at the authorization server and subsequent to the authenticating, an authentication request from the client application; issuing, subsequent to validating the authentication request and by the authorization server, an access token to the client application; detecting, at a resource server associated with the access management system, a request from the client application to access a resource, wherein the request comprises the access token; and enabling, by the resource server and responsive to validating the access token, the client application access to the resource.

Another aspect provides a system for providing access to a resource, the system including: a database; and at least one processing component configured to perform operations including: receiving, at an authorization server associated with the access management system, a login request to a user profile from a client application, wherein the login request comprises a set of login credentials; transmitting, from the authorization server to an identity provider associated with the access management system, the set of login credentials; authenticating, upon validation of the set of login credentials by the identity provider, the user; receiving, at the authorization server and subsequent to the authenticating, an authentication request from the client application; issuing, subsequent to validating the authentication request and by the authorization server, an access token to the client application; detecting, at a resource server associated with the access management system, a request from the client application to access a resource, wherein the request comprises the access token; and enabling, by the resource server and responsive to validating the access token, the client application access to the resource.

A further aspect provides a non-transitory computer-readable medium storing instructions for providing access to a resource via an access management system, the instructions, when executed by one or more processors, causing the one or more processors to perform operations including: receiving, at an authorization server associated with the access management system, a login request to a user profile from a client application, wherein the login request comprises a set of login credentials; transmitting, from the authorization server to an identity provider associated with the access management system, the set of login credentials; authenticating, upon validation of the set of login credentials by the identity provider, the user; receiving, at the authorization server and subsequent to the authenticating, an authentication request from the client application; issuing, subsequent to validating the authentication request and by the authorization server, an access token to the client application; detecting, at a resource server associated with the access management system, a request from the client application to access a resource, wherein the request comprises the access token; and enabling, by the resource server and responsive to validating the access token, the client application access to the resource.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary computer system for executing the techniques described herein, according to one or more embodiments.

FIG. 2 depicts a flow diagram of an exemplary method of authenticating a user, according to one or more embodiments.

FIG. 3 depicts a diagram of an exemplary method of authenticating a client application with an authorization server, according to one or more embodiments.

FIG. 4 depicts a diagram of an exemplary method of publishing assigned user enablements to an authorization server, according to one or more embodiments.

FIG. 5 depicts a diagram of an exemplary method of registering roles and permissions of a resource server with an authorization server, according to one or more embodiments.

FIG. 6 depicts a diagram of an exemplary method of validating an access token by a resource server, according to one or more embodiments.

FIG. 7 depicts a flow diagram of an exemplary method of utilizing a refresh token to obtain a new access token, according to one or more embodiments.

FIG. 8 depicts a table providing exemplary formats for code defining user groups and accessible resources, according to one or more embodiments.

FIG. 9 depicts a table providing exemplary formats for code for a variety of use-cases, according to one or more embodiments.

FIGS. 10(A-B) depict a flowchart of an exemplary method for managing access to a resource, according to one or more embodiments.

FIG. 11 depicts an example of a computing device, according to one or more embodiments.

### DETAILED DESCRIPTION OF EMBODIMENTS

The following embodiments describe systems and methods for managing access and interaction with the diverse resources associated with an entity. More particularly, the embodiments contemplated in the present disclosure provide a framework for a client application to obtain limited access to HTTP resources based on designated user permissions.

Reference to any particular activity is provided in this disclosure only for convenience and is not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “about,” and “generally,” are used to indicate a possible variation of ±10% of a stated or understood value.

As used herein, the term “user” generally encompasses any person or entity that may receive information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software.

As used herein, the term “information handling device” generally encompasses virtually any type of electronic computing device including, for example, laptop and/or personal computers, smart phones, tablet devices, wearable devices, hybrid devices, other types of user devices, and the like. The term “information handling device” may be used interchangeably with, or in place of, any or all of the aforementioned types of computing devices. Additionally, utilization of one of the foregoing terms over another may not be intended to be limiting unless explicitly designated as such.

As used herein, the term “resource” may generally encompass any type of data article generated or owned by or affiliated with an entity. Non-limiting examples of possible entity-affiliated resources include: a document, e.g., a file containing text, images, tables, graphs, charts, any combination of the foregoing, etc., that may be presented in one or more different file formats (e.g., portable document format (PDF), plain text format, virtually any other structured or unstructured format type, etc.); an application portal and the contents contained thereon; a lab test result, and the like. The terms “dataset” and “document” may be used interchangeably herein and the utilization of one term over another is not intended to be limiting unless explicitly designated as such.

As used herein, the terms “group”, “user group”, “group designation”, and the like, may be used interchangeably and may generally refer to a collection of people who may or may not have access to a resource server and/or a specific resource based, at least in part, on membership in the group they belong/are assigned to. For instance, an entity may be composed of a multitude of different departments, each of which may contain department-specific resources. As a requisite to obtaining access to a particular department's resources, a user may need to be associated with that departmental group.

As used herein, the terms “role”, “user role”, “role designation”, and the like, may be used interchangeably and may generally define a user's level of access with respect to a particular resource. More particularly, each role may have predefined designations regarding how they are able to interact with a resource (e.g., one role may allow a user to view the resource, another role may allow the user to view and make edits to the resource, yet another role may allow the user to create new resources within the resource server, etc.). These predefined designations, or permissions, may be registered as “scopes” by the resource server with the authorization server.

As the size of entities increase, so may their accumulated resources. More particularly, the more functions an entity is able to perform (e.g., the more products that are able to be produced and/or sold, the more individuals that can be employed, the more tests that can be run, etc.) the more resources they will likely be able to generate. Additionally, despite all being associated with a singular entity, the nature of each resource may be more localized. For example, in a situation where an entity is composed of several departments, each department may have resources that are specific to that department.

It has conventionally been challenging to effectively control the levels of access individuals may have with an entity's resources, especially if the entity is large and has a vast array of resources with varying levels of sensitivity. For example, two individuals that may be authorized to access a particular resource may not be authorized to interact with that resource in the same way (e.g., one individual may be authorized to view the resource whereas the other individual may be authorized to view and edit the resource).

Controlling access, as well as a level of access, to a resource becomes even more complex when several different entities are involved. As one example, research, such as clinical studies, often involve the participation of different entities, such as medical facilities, and may involve one or more companies cooperating with the medical facilities to perform the clinical studies. One or more hospitals, universities, private physician offices, and companies may participate in research, e.g., a clinical study, and may need to share information with one another to effectively conduct the study. For example, information, also referred to herein as a resource, may be shared with one or more patients, guardians for minor patients, physicians or other medical personnel, medical coordinators, principal investigators, employees of companies, data technicians, researchers, billing specialists, insurance companies, or others. In such an instance, it may not be desirable for all entities, or all people within an entity, to have access to the same information or to be able to interact with the information in the same way. For example, a physician treating certain patients may be able to see patient data and change patient data to reflect the status of a patients' health, while a principal investigator may need to be able to see the health data of all patients being treated at a location, across physicians, but may not need to have the ability to alter patient information. Indeed, some information may also be subject to legal protections, like the Health Insurance Portability and Accountability Act (HIPAA), which may prevent some people from being able to view information or may mean that some people may be able to access some information but not other information, e.g., in order to separate patient identification information from health information. Accordingly, a system is needed that is able to manage an individual's access to, and interaction with, various entity-affiliated resources.

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

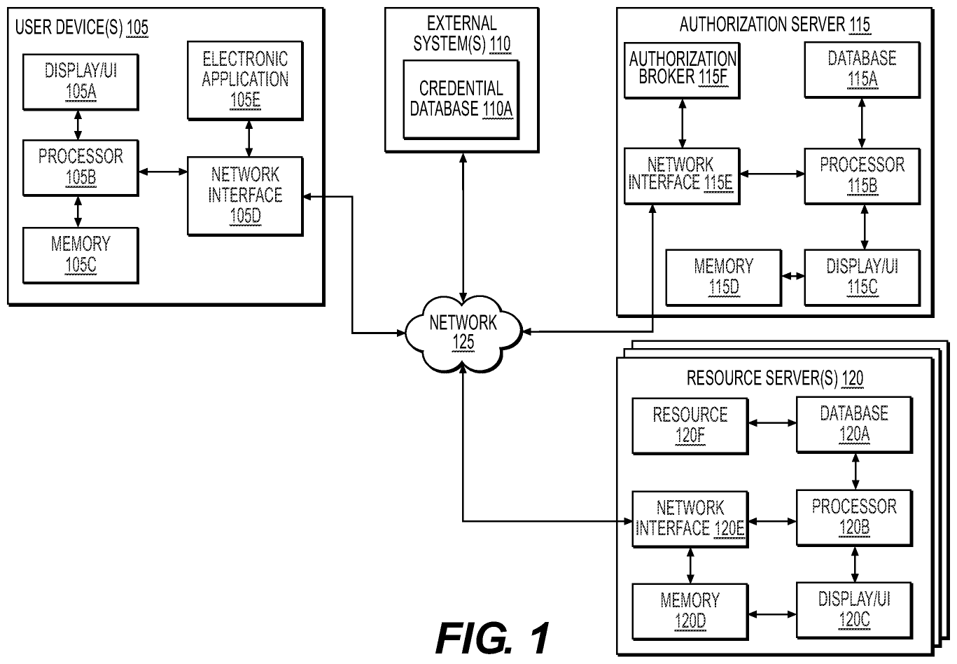

FIG. 1 depicts an exemplary environment 100 for an access management system that may be utilized with techniques presented herein. One or more user device(s) 105, one or more external system(s) 110, and one or more server system(s) 115, 120 may communicate across a network 125. As will be discussed in further detail below, one or more server system(s) 115, 120 may communicate with one or more of the other components of the environment 100 across network 125. The one or more user device(s) 105 may be associated with a user, e.g., a user interested in accessing resources affiliated with an entity. For example, the one or more user device(s) 105 may be associated with a clinical investigator, a physician, a patient, a medical specialist, a corporate resource officer, an administrator, and the like.

In some embodiments, the components of the environment 100 may be associated with a common entity, e.g., a hospital, clinic, medical specialist, research center, document analysis center, corporate partner, corporate client, or the like. In some embodiments, one or more of the components of the environment 100 may be associated with a different entity than another. For example, two entities may be in partnership with one another and may share certain resources to fulfill the goals of that partnership. The systems and devices of the environment 100 may communicate in any arrangement. As will be discussed herein, systems and/or devices of the environment 100 may communicate in order to granularly control access to entity-affiliated resources.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include one or more of a display/user interface (UI) 105A, a processor 105B, a memory 105C, a network interface 105D, and/or an electronic application 105E. The user device 105 may execute, by the processor 105B, an operating system (O/S) an at least one electronic application 105E (each stored in memory 105C). The electronic application 105E may be a desktop program, a browser program, a web client, or a mobile application program (which may also be a browser program in a mobile O/S), an application specific program, system control software, system monitoring software, software development tools, or the like. For example, environment 100 may extend information on a web client that may be accessed through a web browser. In some embodiments, the electronic application(s) 105E may be associated with one or more of the other components in the environment 100. For example, the electronic application 105E may be a client application registered with an access management system that may obtain access to one or more resources 120F on one or more resource servers 120. In an embodiment, the electronic application 105E may manage the memory 105C, such as a database, to transmit streaming data to network 125. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 125. The processor 105B, while executing the application, may generate data and/or receive user inputs from the display/UI 105A and/or receive/transmit messages to the server system 115, and may further perform one or more operations prior to providing an output to the network 125.

External systems 110 may be, for example, one or more third-party and/or auxiliary systems that integrate and/or communicate with the server systems 115, 120 in performing various user access control tasks. For example, the external system(s) may include an identity provider that may be configured to validate user login credentials (e.g., by comparison of the user login credentials to a credential database 110A) and issue identity (ID) tokens, as further described herein. External systems 110 may be in communication with other device(s) or system(s) in the environment 100 over the one or more networks 125. For example, external system(s) 110 may communicate with the authorization server 115 via API (application programming interface) access over the one or more networks 125, and may also communicate with the user device(s) 105 via web browser access over the one or more networks 125.

In various embodiments, the network 125 may be a wide area network (“WAN”), a local area network (“LAN”), a personal area network (“PAN”), or the like. In some embodiments, network 125 includes the Internet, and information and data provided between various systems occurs online. “Online” may refer to connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may be an authorization server and include an electronic data system, e.g., an electronic medical data system, computer-readable memory such as a hard drive, flash drive, disk, etc. In some embodiments, the server system 115 includes and/or may interact with an authorization broker 115G to manage user access controls with respect to resources stored on the resource server(s) 120. The server system 115 may include one or more of a database 115A, a processor 115B, a display U/I 115C, a memory 115D, a network interface 115E, and/or may also include an authorization broker 115F. The server system 115 may be a computer, system of computers (e.g., rack server(s)), and/or or a cloud service computer system. The server system 115 may store or have access to database 115A. The display/UI 115C may be a touch screen or a display with other input systems (e.g., mouse, keyboard, etc.) for an operator of the server system 115 to control the functions of the server system. The server system 115 may execute, by the processor 115B, an operating system (O/S) and at least one instance of a servlet program (each stored in memory 115D). User enablements (e.g., user group designations, user role designations, resources accessible via the user group designations, permissions associated with accessible resources via the user role designations, etc.) with respect to resources stored in the resource server(s) 120 may be stored in memory 115D and/or database 115A. The network interface 115E may be a TCP/IP network interface for, e.g., Ethernet or wireless communications with the network 125.

The electronic application 105E on the user device(s) 105 may be able to access one or more resources 120F contained one or more resource server(s) 120 via the network 125. Each of the one or more resource server(s) 120 may include one or more of a database 120A, a processor 120B, a display U/I 120C, a memory 120D, a network interface 120E, and one or more resources 120F. The user roles, and the permissions associated with each role (i.e., the way an individual assigned to a role is able to interact with a resource 120F) may be contained in the memory database 120A and/or the memory 120D. The display/UI 120C may be a touch screen or a display with other input systems (e.g., mouse, keyboard, etc.) for an operator of the resource server 120 to control the functions of the resource server(s) (e.g., add, edit, or delete resources and/or user roles and/or permissions). The network interface 120E may enable the resource server(s) to communicate and exchange information with one or more other components of the environment 100.

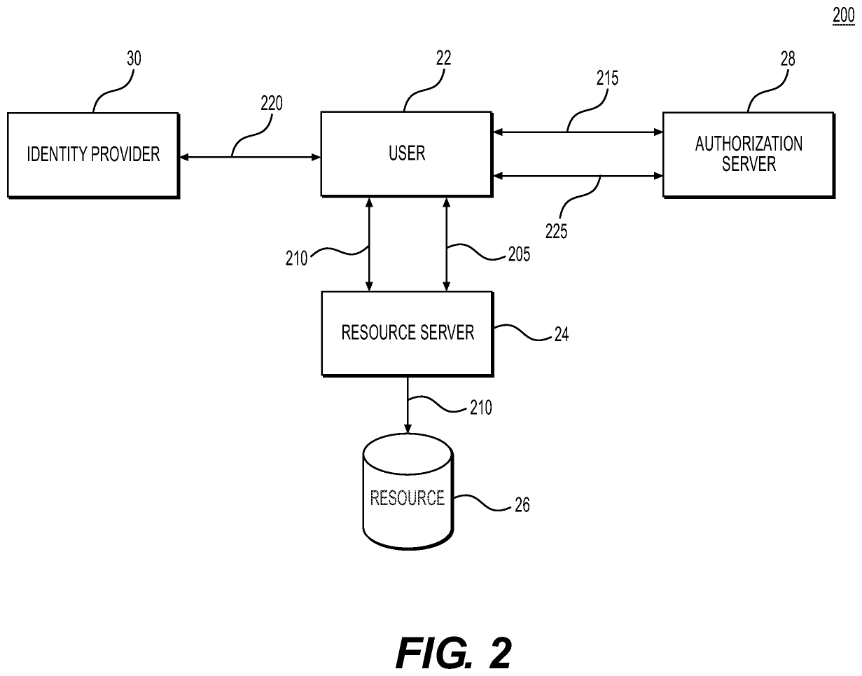

Turning now to FIG. 2, a flow diagram is illustrated of an exemplary method 200 of providing a user access to a resource. Exemplary process flows of the method 200 may be performed in accordance with the environment 100 above. It is important to note that certain aspects of the method 200 may be simplified and that those aspects may be described in greater detail further herein.

A user 22 of a client application may intend to obtain access to resources associated with an entity. The user 22, via interaction with a user interface present on the client application associated with the access management system 100, may initially attempt, at step 205, to directly access the resource 26 controlled by the corresponding resource server 24. Responsive to determining that the user 22 has the proper credentials, the resource server 24 may grant, at step 210, the user 22 access to the resource 26 (assuming additional authentication and authorization procedures are also cleared, as further described herein). However, responsive to determining that the user 22 does not have the proper credentials to access the resource 26 (e.g., because they have not registered a user account with the access management system 100, because they have not logged into their registered user account prior to requesting access to the resource, etc.), the resource server 24 may, at step 215, redirect the user 22 to an authorization server 28 associated with the access management system 100. In an embodiment, the authorization server 28 may be configured to enable the user to register a new user account with the access management system 100 or, alternatively, to login to their existing user account. To facilitate both of these processes, the authorization server 28 may, at step 220, redirect the user 22 to a login screen of an identity provider 30.

With respect to user registration, a user 22 may transmit a registration request to the identity provider 30. In an embodiment, the registration request may be transmitted to the identity provider 30 by any user that simply selects an option to create a new user account. Alternatively, in another embodiment, a user 22 may be unable to create a new user account unless they have been explicitly invited to do so (e.g., by an administrator associated with the access management system 100). In such a situation, a user's acceptance of the invitation may correspond to a request to register with the access management system 100. Upon achieving access to a registration page, a user 22 may be prompted to enter certain articles of registration information (e.g., name, affiliation to an entity, username and password information, etc.).

Users that have previously registered with the access management system 100 may log in to their user account via interaction with the identity provider's 30 login screen (e.g., via provision of their username/password key pair, etc.). Once received by the identity provider 30, the user's 22 provided login credentials may be compared against a listing of authorized credentials located in a credential database of the identity provider 30. Responsive to determining that no match exists between the user's 22 provided login credentials and the listing of authorized credentials located in the credential database, the identity provider 30 may deny access to a user account and/or prompt the user 22 to re-enter their login credentials. Conversely, responsive to determining that a match does exist between the user's 22 provided login credentials and the listing of authorized credentials located in the credential database, then the identity provider 30 may, at step 225, issue and transmit, via the authorization server 28, an identity (ID) token to the client application.

In an embodiment, the access token is the security token that contains claims about the authentication of the user 22. Stated differently, the access token may describe how and when the user 22 authenticated at the authorization server 28/identity provider 30. The access token aids in proving the user's identity and authenticating the user 22 for use of a service (e.g., in the obtainment of requested resources, etc.). In an embodiment, the access token contains a plurality of designations, or “claims”, that specify one or more of: the issuer of the token (i.e., the identity provider), the audience of the token (e.g., the client application that made the authentication request), the subject identifier of the end-user, the expiration date of the access token, and the creation or issuance date of the token. In an embodiment, the access token may contain one or more optional claims such as: the authorization time at which the end-user last authenticated with the identity provider, the authentication method reference (i.e., a collection of values that describe how the user authenticated with the identity provider 28 such as, for example, via a username/password key pair, multi-factor authentication (MFA), etc.), the authentication context reference (i.e., a collection of values that describe the levels to which authentication took place), a nonce value (i.e., a random value generated by the client application and included in the authentication request), a session identifier, one or more identity claims (e.g., a user's name, preferred username, email, etc., that are generally utilized for user interface (UI) display), and the like.

In an embodiment, the access token may be a JSON Web Token (JWT) that, when received at the client application, may be validated. In an embodiment, the validation process of the access token by the client application may involve: retrieving, e.g., from the authorization server, a JSON Web Key Set (JWKS), decoding the access token if it is encrypted, utilizing the retrieved JWKS to verify the access token signature (e.g., by matching the key that was used to sign the access token with the corresponding key retrieved from the authorization server's JWK endpoint), and verifying the accuracy of the claims (e.g., by ensuring that: the issuer claim matches the identifier of the access provider/authorization server, the audience claim matches the Client ID of the client application used to request the access token, an expiration time designated in the expiration claim has not already passed, the nonce claim value matches the value included in the original authentication request, etc.).

Responsive to determining that the access token cannot be validated, the client application may prevent the user from accessing their user account. Conversely, upon successful validation of the access token, the client application may grant the user access to their user account. Additionally, subsequent to validation of the access token, the authorization server 28 may access user information associated with the user 22 to facilitate access to the resource 26 stored in the resource server 24, using processes further described herein.

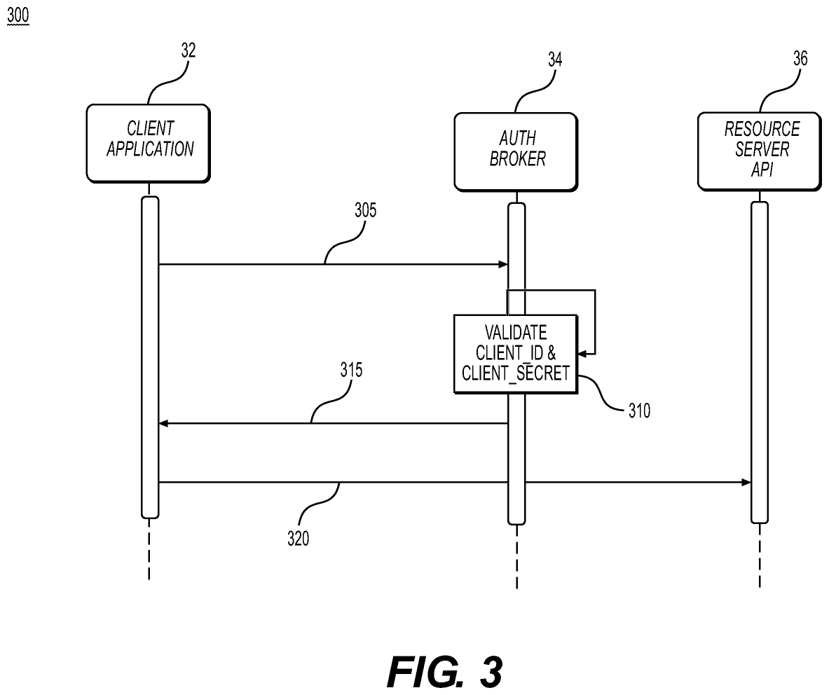

Turning now to FIG. 3, a diagram 300 is presented that illustrates an application authentication process. Exemplary process flows of the diagram 300 may be performed in accordance with the system 100 and the method 200, as previously described above.

With machine-to-machine (M2M) applications, such as those utilized and described herein, an access management system may authenticate and authorize a client application. More particularly, upon receiving correct login credentials from a user to access a specific user account on an application platform, as previously described in process flow 200 in FIG. 2, a client application 32 may automatically transmit, at step 305, an authentication request to an authorization broker 34 of an authorization server. In an embodiment, the authentication request may contain a Client ID and a Client Secret. With respect to the former, the Client ID may be an auto-generated alphanumeric string that is a public identifier of the client application 32. It may be utilized in the initial redirect to identify the client application 32 to the authorization broker 34. With respect to the latter, the Client Secret may also be an auto-generated alphanumeric string that is known to the client application 32 and authorization broker 34 but not other system components. It may be utilized to authenticate the client application 32 to the authorization broker 34 for downstream receipt and utilization of access and refresh tokens, as later described herein. At step 310, an embodiment may attempt to validate the application authentication request based on the Client ID and the Client Secret. In this regard, the authorization broker 34 may identify that the alphanumeric string associated with the Client ID corresponds to a previously registered application and that the alphanumeric string associated with the Client Secret corresponds to an authorized alphanumeric string known to the authorization broker 34 but not other system components.

Subsequent to validation of the Client ID and Client Secret, the authorization broker 34 may, at step 315, issue an access token to the client application 32. If the Client ID and Client Secret cannot be validated by broker 34, then step 315 may not be performed. Conversely, in an embodiment in which validation is successful, the issued access token may enable access to one or more resources resident on a resource server 36. More particularly, the access token may inform the resource server 36 that the bearer of the access token has been authorized to access one or more resources stored on the resource server 36 and to perform specific actions with respect to those resources (i.e., as specified by the permissions that were granted during authorization, as further described herein).

In an embodiment, the access token may be a JWT that is signed and encrypted by an OIDC Provider (e.g., manifest in the embodiments described herein as an authorization broker) resident within an authorization server, using, e.g., a public/private key pair. Although a variety of different signing algorithms may be utilized to sign the access token, the embodiments herein are described in reference to utilization of the RS256 asymmetric signing algorithm. However, such a designation is not limiting and other signing algorithms may also be utilized (e.g., the HS256 symmetric algorithm).

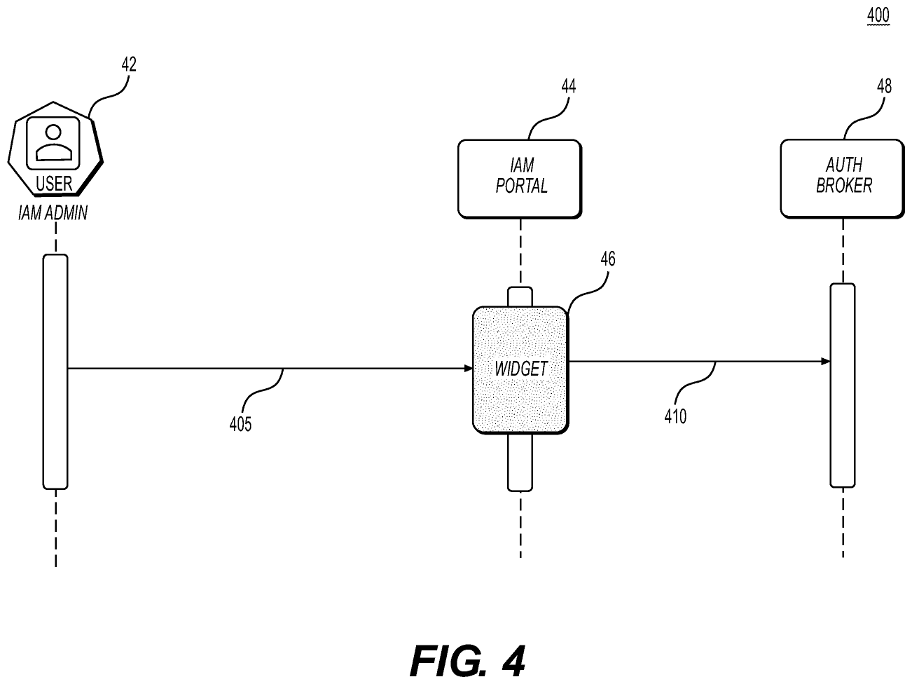

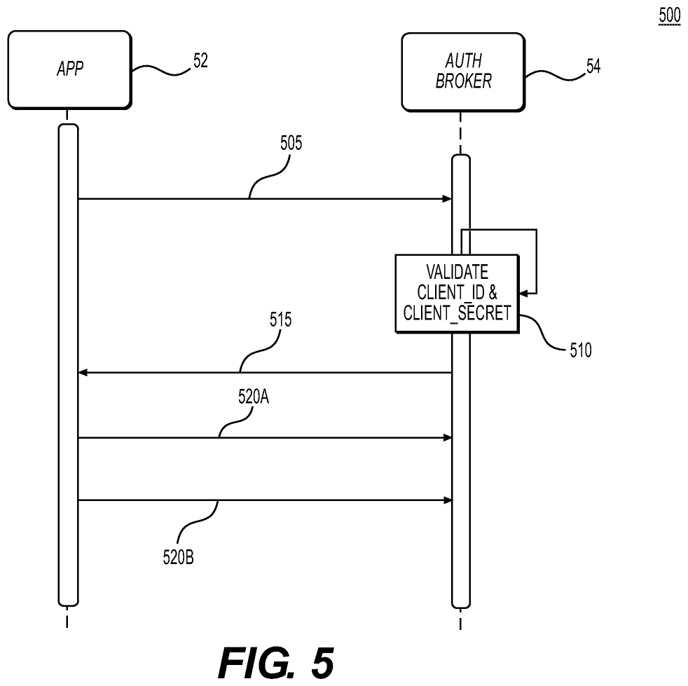

In an embodiment, each access token may contain a variety of different types of information embedded within it. For example, an access token may contain one or more of: an indication of a token expiration date (i.e., after which the token may no longer be effectively utilized in various downstream processes), one or more user group designations, an indication of the resources accessible to the members of each designated group, one or more user role designations, an indication of the permissions available to the user with respect to a resource based on their role designation, and the like. The types of information that may be embedded into the access token, and the processes for embedding the information, are further described below in the diagrams illustrated in FIGS. 4-5. In an embodiment, the client application may, at step 320, transmit a resource access request to a resource server 36. In an embodiment, the resource access request may contain the access token and may request production, by the resource server 36, of a particular resource. Thereafter, the resource server 36, using processes described in greater detail further herein, may analyze the resource access request to determine whether to produce the requested resource and to identify a user's enablements with respect to that resource.

Turning now to FIG. 4, a flow diagram 400 is presented that illustrates a user management process. In an embodiment, an Information and Access Management Administrator (IAM Admin) 42 may exist that has a number of responsibilities involving the assignment of enablements for each user (i.e., each user's access and permission levels with respect to different resources affiliated with a particular entity). In an embodiment, the IAM Admin 42 may be a human individual tasked with this position. More particularly, the IAM Admin 42 may manage the enablements of the users based on available identifying information (e.g., the user's identity, the user's professional position, etc.).

At step 405, the IAM admin 42 may construct, e.g., using an IAM Portal 44 accessible via interaction with a widget 46 that may interact with the authorization broker 48 of the authorization server, groups and assign registered users to these groups. In the context of this application, each group constructed by the IAM admin 42 may contain an access grant with respect to one or more resources. Stated differently, the group designation may define the resources that the members of the group have access to. For example, users assigned to Group One may have access to Test Data A on a Patient Portal, users assigned to Group Two may have access to Test Data B on the Patient Portal, and users assigned to Group Three may have access to both of the foregoing types of test data. The IAM admin 42 may also assign specified roles to each user. These role assignments may dictate the levels of access (i.e., “permissions”) each user has with respect to a particular resource, as further described below with respect to FIG. 5. Once completed, these group and role assignments may be transmitted and published, at step 410, to an authorization broker 48 of the authorization server.

Although previously described with reference to a human individual, embodiments exist in which the responsibilities associated with the IAM admin 42 may be automated. More particularly, a dedicated artificial intelligence (AI) software agent (e.g., embodied as a digital assistant, etc.) may dynamically allocate enablements to new and existing users based upon analysis of their available identifying information. For example, having knowledge of one or more of: a user's professional position, the role of that position with respect to various entity-affiliated resources, how long the user has been in that position, the relationship of the user to the resource (e.g., a patient or parent of a minor patient and the patient's medical records), and the like, the AI-based IAM Admin may dynamically place the user into one or more groups and role assignments.

Turning now to FIG. 5, a flow diagram 500 is presented that illustrates a permissions registration process of a resource server 52 with an authorization broker 54 of an authorization server. In an embodiment, each resource server 52 may be able to register the applicable roles and scopes (i.e., the permissions that define interaction levels with a resource on the resource server 52 that are granted to a user based on their assigned role) associated therewith with the authorization broker 54 of the authentication server. In an embodiment, steps 505-515 of the scope registration process may be similar in nature to steps 305-315 as previously described above with reference to the flow diagram 300 illustrated in FIG. 3. More particularly, the resource server 52 may, at steps 505 and 510, authenticate itself with the authorization broker 54 and receive, at step 515, a corresponding access token that serves as the output of this process. Subsequent to validation of the resource server 52 and issuance of the access token, the resource server 52 may, at steps 520a and 520b, register the roles and associated permissions with the authorization broker 54.

A non-limiting example is subsequently provided that clarifies the nature of the relationship between groups and roles in the context of entity-affiliated resources. In an exemplary situation, User A and User B may both be assigned to Group One by an IAM Admin. Members of Group One may be able to obtain access to Resource R. User A may be assigned the role of Clinical Investigator whereas User B may be assigned the role of Physician. The Clinical Investigator role may, based on the designated permissions associated with the role as defined by Resource R, be able to perform action X (e.g., a read operation). In contrast, the Physician role may, based on the designated permissions associated with the role as defined by Resource R, be able to perform actions X and Y (e.g., a create operation). If the IAM Admin chose to change the role of User A to Physician, then User A may also be able to perform the actions of X and Y with Resource R.

Referring back to step 315 in FIG. 3, the authorization broker 34 may embed, in the issued access token, access permissions for the identified user for each relevant resource server 36. More particularly, having knowledge of the groups and roles a user has been assigned to (i.e., based on the information provided to the authorization broker 34 from the IAM Admin 42 by the process depicted in diagram 400), as well as the permissions that are associated with each role (i.e., based on the information provided to the authorization broker 34 by each resource server 52 via the process depicted in diagram 500), the authorization broker 34 may enable granulized levels of access control across all resources by utilization of the single access token. Accordingly, a client application 32 requesting access to a specific resource 36 may transmit, at step 320, a resource access request along with the access token to the relevant resource server 36. The resource server 36 may thereafter decrypt and analyze the data embedded in the access token to identify the allotted permissions the client application 32 has with respect to the resource, as further described below.

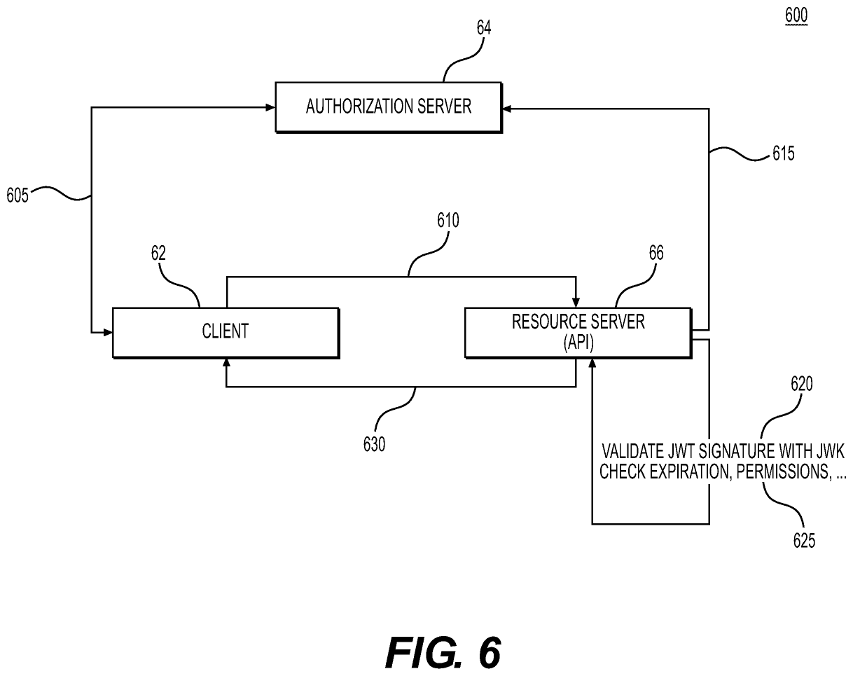

Turning now to FIG. 6, a flow diagram 600 is presented that illustrates an access token validation process by the resource server. At step 605, a client application 62 may acquire an access token from an authorization broker of an authorization server 64 by sending a request to authorization server 64, e.g., using the process described above with respect to FIG. 3. Subsequent to receipt of the access token from the authorization server 64, the client application 62 may transmit, at step 610, the access token to a designated resource server 66 (i.e., the resource server holding the resource a user intends to access). Upon receipt of the client application's resource request, the resource server 66 may retrieve, at step 615, the public key (i.e., the JSON Web Key) from the authorization broker of the authorization sever 64. The resource server 66 may thereafter utilize the public key to validate, at step 620, the access token signature. More particularly, if the signature utilized to sign and encrypt the access token was generated by the private key held by the authorization broker, then the corresponding public key would be able to validate it (i.e., decrypt the access token). Responsive to validating the access token, the resource server 66 may then identify, at step 625, relevant information contained within the access token. For example, the resource server 66 may check any expirations associated with the access token to ensure that it is still valid, identify the group and/or role designations associated with the user, the resource(s) accessible on the resource server 66 based on the group designation, the access levels with the resource based on the role designation, and the like. Thereafter, the resource server 66 may enable, at step 630, the client application 62 access to the requested resource. In an embodiment, the enablement of resource access by the resource server 66 may correspond to one or more of: an allowance of the client application 62 to interact with the resource on the resource server 66, a transmission of the requested resource to the client application 62, or portions of both of the foregoing (e.g., portions of a resource may be transmitted to the client application 62 whereas other portions of the resource remain on the resource server 66 and need to be interacted with there).

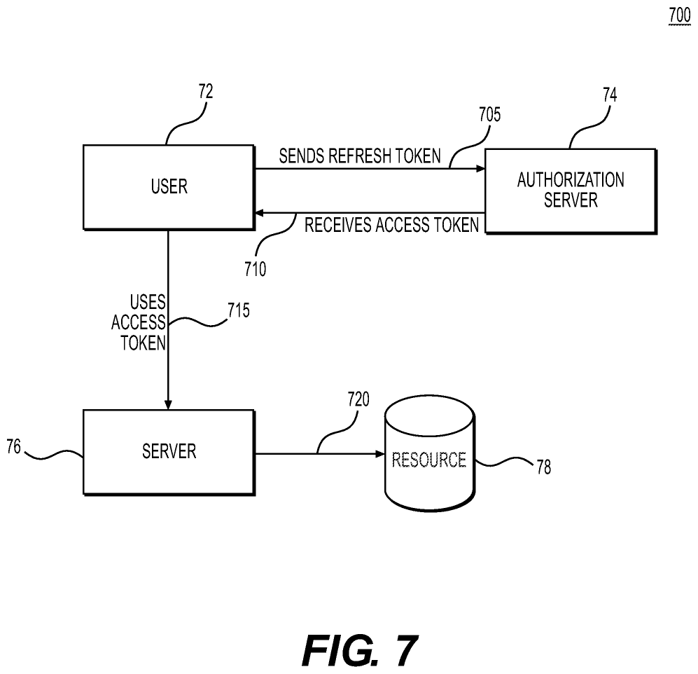

Turning now to FIG. 7, a flow diagram 700 is presented that illustrates how refresh tokens may be utilized to request new access tokens. Conventionally, refresh tokens may enable client applications to request new access tokens, and refresh tokens may be issued to the client application along with access tokens. For instance, after a validity period for an access token has expired, a client application may transmit a request for a new access token to the authorization server. For this request to return a new access token, a refresh token may be needed. The refresh token may represent to the authorization server that a user and/or client application has been previously authenticated to receive access tokens. Additionally, in contrast to access tokens, which are generally short-lived (e.g., 1 week, 2 weeks, 30 days, 60 days, 90 days, etc.), refresh tokens may have a comparatively longer validity date (e.g., 2 months, 4 months, 6 months, 9 months, 1 year, 2 years, etc.).

Accordingly, in view of the foregoing, a user 72 may, at step 705, request a new access token from the authorization server 74 via transmission of an available refresh token. Upon receipt and validation of the refresh token, the authorization server 74 may, at step 710, transmit the access token back to the user 72. The user 72 may thereafter leverage the abilities of the new access token to request and receive, at steps 715 and 720 respectively, a resource 78 from a resource server 76, as previously described herein.

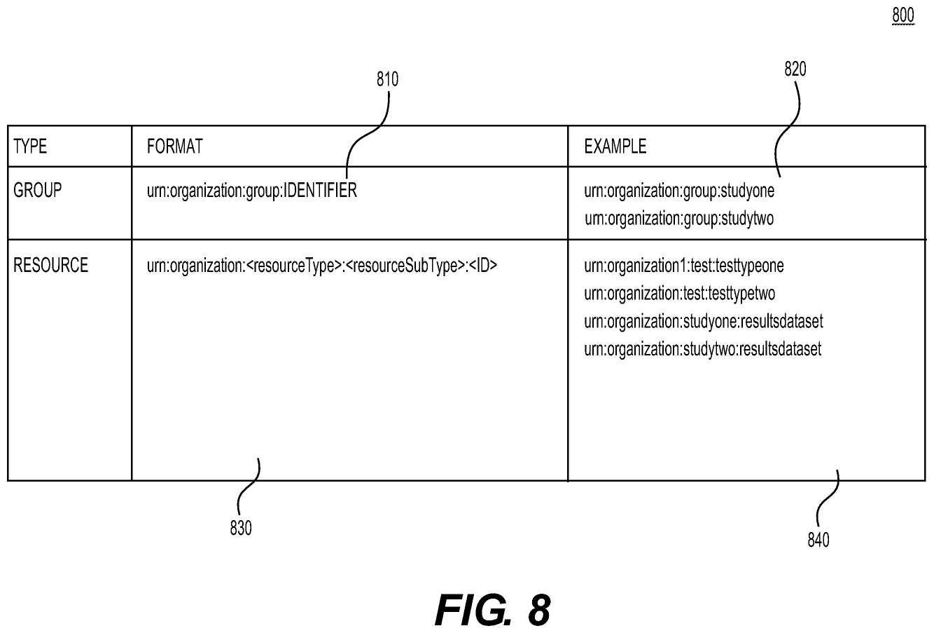

Turning now to FIG. 8, exemplary formats for code defining user groups and accessible resources are provided. In an embodiment, the code string may be an Internet resource in the form of a uniform resource name (URN). Unlike a Uniform Resource Locator (URL), a URN may have persistent significance, i.e., the owner of the URN can expect that another individual may always be able to find the resource. More particularly, whereas URLs may need a user to know where a resource is located as well as how to spell the name of the file and suffix, a URN may need a user to know the name of a resource, after which one or more software agencies may be able to locate the nearest copy of the resource. The foregoing may thereby free the user from understanding where resources are located or relocated to.

In an embodiment, the code format for a group designation may be “urn:organization:group:IDENTIFIER”, as illustrated in box 810 of table 800. A non-limiting example of a use-case having this code format is provided in box 820, e.g., “urn:organization:group:studyone”. In this situation, a user may be part of a group associated with a particular case study, i.e., “casestudyone”. In an embodiment, the code format for a resource designation may be “urn:organization:<resourceType>:<resourceSubType>:<ID>”, as illustrated in box 830. Non-limiting example use-cases having this code format are provided in box 840, e.g., “urn:organization:test:testtypeone” and “urn:organization:test:testtypetwo”. In this situation, each of these URN strings identifies a different test type as the resource (e.g., the former URN string specifies a test resource generically named “testtypeone” and the latter URN string specifies a test resource generically named “testtypetwo”).

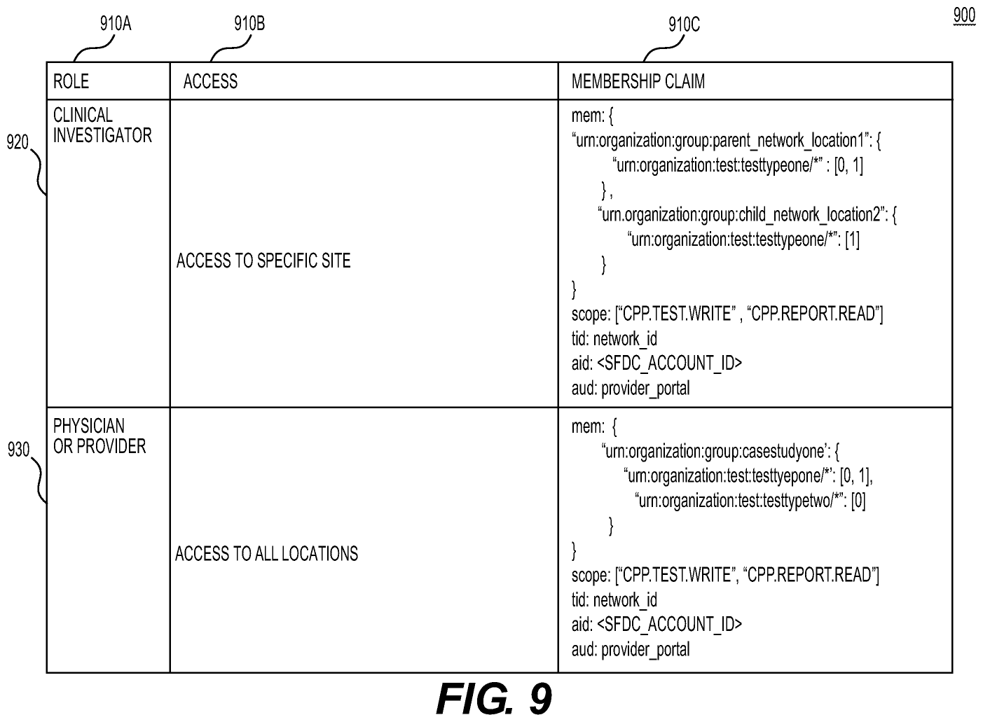

In view of the format designations delineated in FIG. 8, a plurality of exemplary code formats for different non-limiting use cases are provided in FIG. 9. More particularly, table 900 provides an indication of a user's role 910A and the access designation 910B they may have with respect to a resource server 910C (i.e., a Provider Portal).

In a first example, at 920, a clinical investigator may have access to a specific site in a group. More particularly, the clinical investigator may have a group membership to “parent_network_location1” and “child_network_location2”, both of which give access to the “testtypeone” test data associated with each group. Furthermore, it can be seen (i.e., based on the permissions designated by the scopes) that the clinical investigator may perform both, a “write” operation and a “read” operation, with respect to the “testtypeone” test data in the “parent_network_location1” group but a “read” operation with respect to the “testtypeone” test data in the “child_network_location2” group.

In a second example, at 930, a physician may have access to all locations in a given group. More particularly, the physician may have a group membership to “casestudyone” that gives access to all available resources associated with the “casestudyone” group, i.e., the “testtypeone” test data and the “testtypetwo” test data. Furthermore, it can be seen (i.e., based on the permissions designated by the scopes) that the physician may perform both, a “write” operation and a “read” operation, with respect to the “testtypeone” test data but just a “read” operation with respect to the “testtypetwo” test data.

In an embodiment, each user registered with the access management system 100 and assigned to a group may be assigned default scopes, i.e., permissions within a group. For example, each user newly assigned to a group may be assigned an “iam.group.read” permission so that they can see users from within their group and collaborate with others. In an embodiment, these scopes may later be adjusted, e.g., by a group administrator who may have both read and write permissions, the latter enabling them to manage group settings.

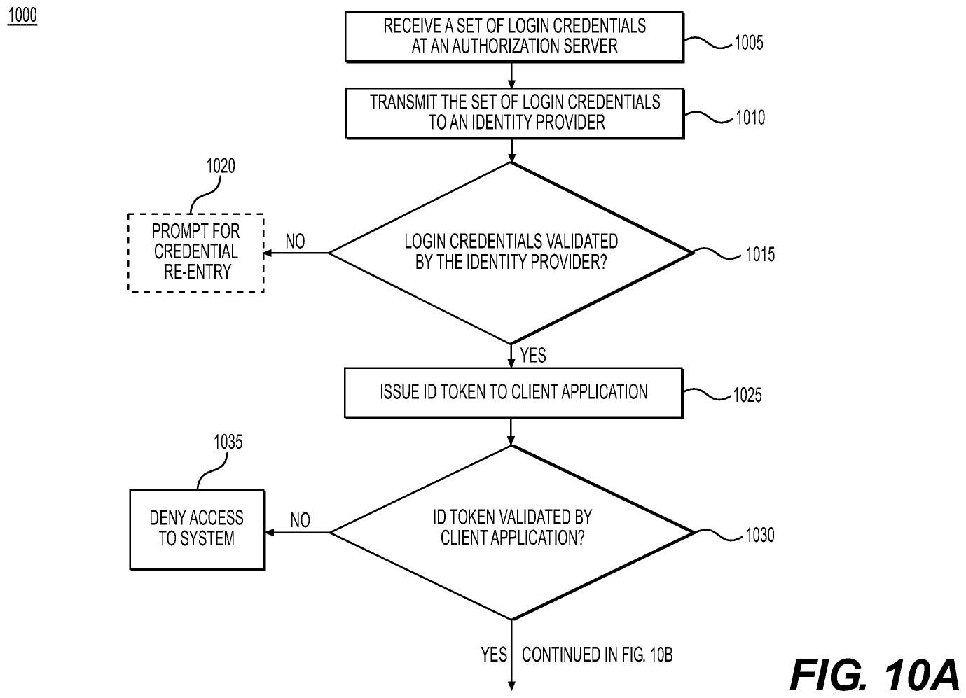

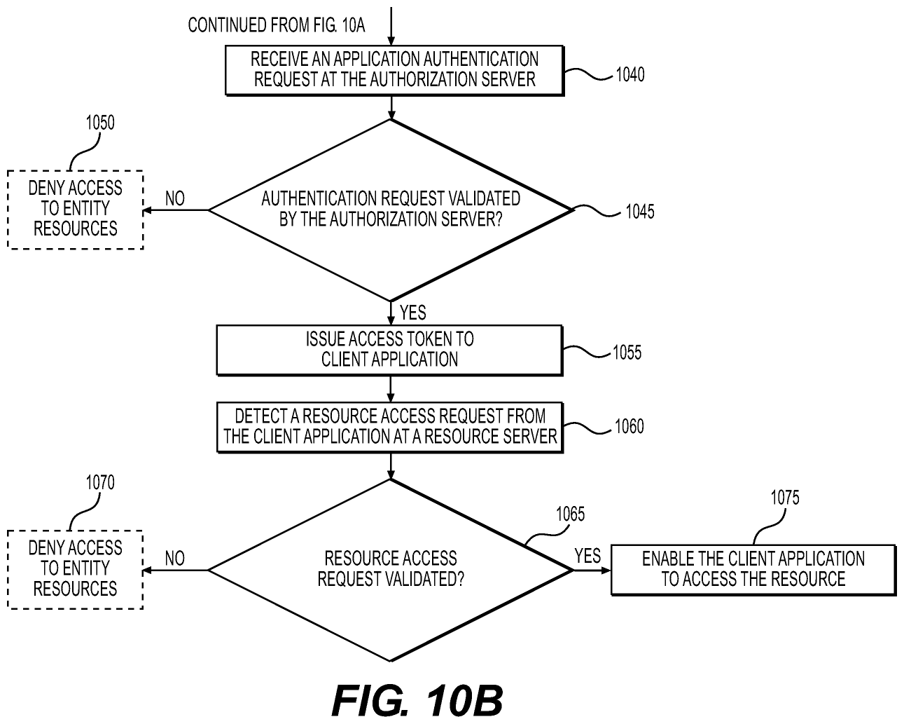

Turning now to FIGS. 10A and 10B, an exemplary process for managing access to resources associated with an entity is illustrated. Exemplary process flows of the method 1000 may be performed in accordance with the system 100 above along with the various processes described in FIGS. 2-7.

At step 1005, a login request may be received at an authorization server of an access management system associated with an entity. In an embodiment, the login request may contain a set of user login credentials (e.g., a username/password pair, etc.). In an embodiment, the login credentials may be input into one or more input fields of a user interface present on an application platform associated with the access management system.

At step 1010, the received login credentials may be transmitted by the authorization server to an identity provider. The identity provider may contain a database storing a list of authorized login credentials (i.e., wherein the authorized login credentials correspond to users previously registered with the access management system).

At step 1015, the identity provider may attempt to validate the login credentials, e.g., by comparing the login credentials to the list of authorized login credentials stored in the database. Responsive to determining, at 1015, that the login credentials are not valid (i.e., via identifying that a match does not exist between the received login credentials and the authorized credentials stored in the database), an embodiment may, at 1020, deny the user access the access management system. Additionally or alternatively, an embodiment may provide a notification alert on the client application informing the user that the application could not be validated. Additionally or alternatively, an embodiment may provide a prompt to the user instructing them to re-enter their login credentials. Conversely, responsive to determining, at 1015, that the login credentials are valid (i.e., via identifying that a match exists between the received login credentials and the authorized credentials stored in the database), an embodiment may, at 1025, issue an ID token to the client application.

At step 1030, the ID token may be validated by the client application. More particularly, the client application may decrypt the ID token if it is encoded and confirm that the information contained in one or more claims of the ID token is valid, as previously discussed. Responsive to determining, at step 1030, that the ID token is not valid, an embodiment may, at step 1035, deny the user access to the access management system. Additionally or alternatively, an embodiment may provide a notification alert on the client application informing the user that the application could not be validated. Conversely, responsive to determining, at step 1030, that the ID token is valid, an embodiment may proceed with the authentication of the client application.

At step 1040, an application authentication request may be received at the authorization server. In an embodiment, the application authentication request may contain one or more types of articles utilized in the application authentication process, e.g., a Client ID and a Client Secret. At step 1045, an embodiment may attempt to validate the application authentication request. In this regard, the authorization server may: identify that the alphanumeric string associated with the Client ID corresponds to a known application and that the alphanumeric string associated with the Client Secret corresponds to an authorized alphanumeric string known to the authorization server. Responsive to determining, at step 1045, that the application authentication request cannot be validated, an embodiment may, at step 1050, deny the client application access to the resources associated with the entity. Additionally or alternatively, an embodiment may provide a notification alert on the client application informing the user that the application could not be authenticated. Conversely, responsive to validating the application authentication request, an embodiment may, at step 1055, issue an access token to the client application.

In an embodiment, the access token may be a JWT token that may be embedded with various types of user enablement data with respect to one or more resource servers. For example, the access token may contain one or more indications associated with: a user role designation, a user group designation, resources accessible to the user based on the group designation, user permissions with those accessible resources based on the role designation, and the like. In an embodiment, the aforementioned designations may be assigned manually, e.g., by one or more human administrators or, alternatively, may be assigned dynamically, e.g., by an AI system analyzing available context data associated with the user. In an embodiment, the access token may also be encrypted by the authorization server utilizing, e.g., a private key signature.

At step 1060, a resource access request from the client application may be detected at a resource server associated with the access management system. In an embodiment, the resource access request may identify the resource that the client application intends to access. Additionally, the resource access request may transmit, to the resource server, the aforementioned access token. Once received, the resource server may, at step 1065, attempt to validate the access request. In this regard, the resource server may perform one or more of the following steps: 1) decrypt the access token (e.g., by utilizing a public key, retrieved from the authorization server, that corresponds to the private key utilized to encrypt the access token) if it is encrypted; 2) identify the resources accessible to the user based on their designated enablements per the group to which the user is assigned; and 3) determine whether the manner in which a user seeks to interact with a resource is allowed based on their allotted enablements per the role to which the user is assigned. Responsive to being unable to perform any one of the foregoing three steps or upon determining a mismatch between a request and an enablement to which the user is assigned, at step 1065, an embodiment may, at step 1070, deny access to the requested resource. Additionally or alternatively, an embodiment may return a notification to the client application explaining why their resource access request was denied. Conversely, responsive to validating, at step 1065, the resource access request, an embodiment may, at step 1075, enable the client application to access the resource and interact with it based on the designated user enablements.

It should be understood that embodiments in this disclosure are exemplary only, and that other embodiments may include various combinations of features from other embodiments, as well as additional or fewer features. For example, while some of the embodiments above pertain to access control with respect to the resources associated with a pharmaceutical entity, access to the resources of virtually any other type of entity may similarly be controlled using the systems and techniques described above.

In general, any process or operation discussed in this disclosure that is understood to be computer-implementable, such as the processes illustrated in FIGS. 2-7 and 10, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

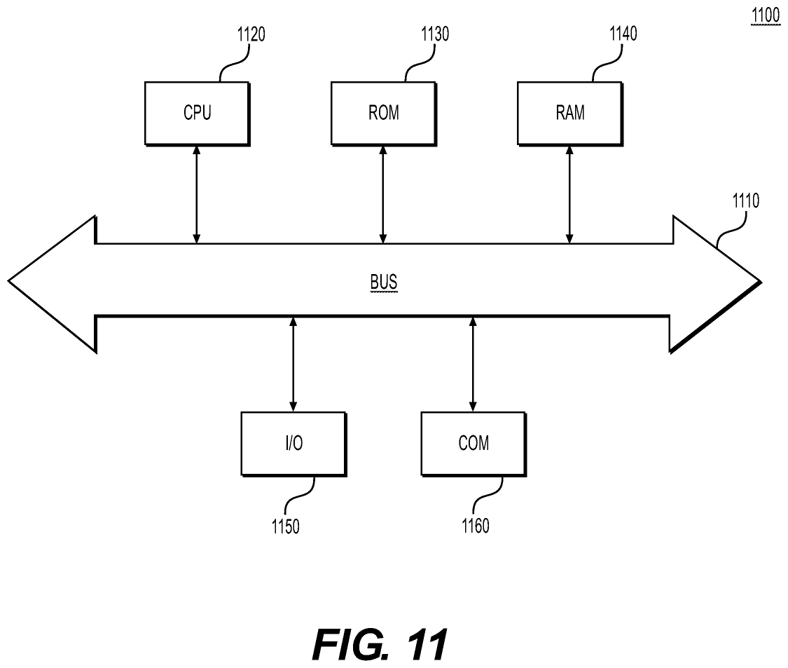

FIG. 11 is a simplified functional block diagram of a computer 1100 that may be configured as a device for executing the methods of FIGS. 2-7 and 10, according to exemplary embodiments of the present disclosure. For example, device 1100 may include a central processing unit (CPU) 1120. CPU 1120 may be any type of processor device including, for example, any type of special purpose or a general-purpose microprocessor device. As will be appreciated by persons skilled in the relevant art, CPU 1120 also may be a single processor in a multi-core/multiprocessor system, such system operating alone, or in a cluster of computing devices operating in a cluster or server farm. CPU 1120 may be connected to a data communication infrastructure 1110, for example, a bus, message queue, network, or multi-core message-passing scheme.

Device 1100 also may include a main memory 1140, for example, random access memory (RAM), and also may include a secondary memory 1130. Secondary memory 1130, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 1130 may include other similar means for allowing computer programs or other instructions to be loaded into device 1100. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 1100.

Device 1100 also may include a communications interface (“COM”) 1160. Communications interface 1160 allows software and data to be transferred between device 1100 and external devices. Communications interface 1160 may include a modem, a network interface (such as an Ethernet card), a communications port, a PCMCIA slot and card, or the like. Software and data transferred via communications interface 1160 may be in the form of signals, which may be electronic, electromagnetic, optical, or other signals capable of being received by communications interface 1160. These signals may be provided to communications interface 1160 via a communications path of device 1100, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 1100 also may include input and output ports 1150 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, a laboratory computing system, an office computing environment, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method of providing access to a resource via an access management system, the method comprising:
receiving, at an authorization server associated with the access management system, a login request to a user profile from a client application, wherein the login request comprises a set of login credentials;
transmitting, from the authorization server to an identity provider associated with the access management system, the set of login credentials;
authenticating, upon validation of the set of login credentials by the identity provider, the user;
receiving, at the authorization server and subsequent to the authenticating, an authentication request from the client application;
issuing, subsequent to validating the authentication request and by the authorization server, an access token to the client application;
detecting, at a resource server associated with the access management system, a request from the client application to access a resource, wherein the request comprises the access token; and
enabling, by the resource server and responsive to validating the access token, the client application access to the resource.

2. The method of claim 1, wherein the access token is a JSON Web Token (JWT).

3. The method of claim 1, wherein the validating the authentication request comprises:
identifying, within the authentication request, a Client ID and a Client Secret; and
validating, responsive to determining that the Client ID corresponds to a known Client ID and the Client Secret corresponds to a known Client Secret; the authentication request.

4. The method of claim 1, wherein the issuing the access token comprises:
embedding, within the access token, user enablement data with respect to the resource server; and
encrypting, utilizing a private key, the access token.

5. The method of claim 4, wherein the user enablement data comprises one or more of: a user group designation and a user role designation;
wherein the user group designation provides authorization to access the resource server; and
wherein the user role designation delineates a level of access with the resource on the resource server to the resource server.

6. The method of claim 5, wherein the user group designation and/or the user role designation are manually assigned by an administrator associated with the access management system.

7. The method of claim 5, wherein the user group designation and/or the user role designation are dynamically determined based upon analysis of information embedded within the ID token.

8. The method of claim 5, wherein the validating the access token comprises:
retrieving, from the authorization server, a public key corresponding to the private key;
decrypting, utilizing the public key, the access token;
authorizing, subsequent to the decrypting, access to the resource server based on the user group designation; and
identifying, based on the user role designation, user permissions with respect to the resource.

9. The method of claim 8, wherein the enabling comprises enabling a level of interaction with the resource based on the user permissions.

10. The method of claim 1, further comprising:
receiving, at the authorization server and at a time after an expiration date associated with the access token, a request for a new access token;
validating, at the authorization server, a refresh token; and
issuing, subsequent to the validating, the new access token.

11. A system for providing access to a resource, the system comprising:
a database; and
at least one processing component configured to perform operations including:
receiving, at an authorization server associated with the access management system, a login request to a user profile from a client application, wherein the login request comprises a set of login credentials;
transmitting, from the authorization server to an identity provider associated with the access management system, the set of login credentials;
authenticating, upon validation of the set of login credentials by the identity provider, the user;
receiving, at the authorization server and subsequent to the authenticating, an authentication request from the client application;
issuing, subsequent to validating the authentication request and by the authorization server, an access token to the client application;
detecting, at a resource server associated with the access management system, a request from the client application to access a resource, wherein the request comprises the access token; and
enabling, by the resource server and responsive to validating the access token, the client application access to the resource.

12. The system of claim 11, wherein the access token is a JSON Web Token (JWT).

13. The system of claim 11, wherein the operations to validate the access request further comprise:
identifying, within the authentication request, a Client ID and a Client Secret; and
validating, responsive to determining that the Client ID corresponds to a known Client ID and the Client Secret corresponds to a known Client Secret; the authentication request.

14. The system of claim 11, wherein the operations to issue the access token further comprise:
embedding, within the access token, user enablement data with respect to the resource server; and
encrypting, utilizing a private key, the access token.

15. The system of claim 14, wherein the user enablement data comprises one or more of: a user group designation and a user role designation;
wherein the user group designation provides authorization to access the resource server; and
wherein the user role designation delineates a level of access with the resource on the resource server.

16. The system of claim 15, wherein the user group designation and/or the user role designation are manually assigned by an administrator associated with the access management system.

17. The system of claim 15, wherein the operations to validate the access token further comprise:
retrieving, from the authorization server, a public key corresponding to the private key;
decrypting, utilizing the public key, the access token;
authorizing, subsequent to the decrypting, access to the resource server based on the user group designation; and
identifying, based on the user role designation, user permissions with respect to the resource.

18. The system of claim 15, wherein the operations to enable further comprise:
enabling a level of interaction with the resource based on the user permissions.

19. The system of claim 11, wherein the operations further comprise:
receiving, at the authorization server and at a time after an expiration date associated with the access token, a request for a new access token;
validating, at the authorization server, a refresh token; and
issuing, subsequent to the validating, the new access token.

20. A non-transitory computer-readable medium storing instructions for providing access to a resource via an access management system, the instructions, when executed by one or more processors, causing the one or more processors to perform operations comprising:
receiving, at an authorization server associated with the access management system, a login request to a user profile from a client application, wherein the login request comprises a set of login credentials;
transmitting, from the authorization server to an identity provider associated with the access management system, the set of login credentials;
authenticating, upon validation of the set of login credentials by the identity provider, the user;
receiving, at the authorization server and subsequent to the authenticating, an authentication request from the client application;
issuing, subsequent to validating the authentication request and by the authorization server, an access token to the client application;
detecting, at a resource server associated with the access management system, a request from the client application to access a resource, wherein the request comprises the access token; and
enabling, by the resource server and responsive to validating the access token, the client application access to the resource.
